(19) United States
(12) Patent Application Publication
(10) Pub. No.: US 2022/0050689 A1
(43) Pub. Date: Feb. 17, 2022

(54) CONDITIONAL FIRMWARE IMAGES

(71) Applicant: HEWLETT-PACKARD DEVELOPMENT COMPANY, L.P., Spring, TX (US)

(72) Inventors: Binh Truong, 10300 Energy Drive, TX (US); King-Yan Lau, San Diego, CA (US); Chi So, Spring, TX (US)

(73) Assignee: HEWLETT-PACKARD DEVELOPMENT COMPANY, L.P., Spring, TX (US)

(21) Appl. No.: 17/414,395

(22) PCT Filed: Dec. 20, 2018
(86) PCT No.: PCT/US2018/066870

§ 371 Date: Jun. 16, 2021

(51) Int. Cl. G06F 9/445

(52) U.S. Cl. CPC G06F 9/445

(57) ABSTRACT

In an example implementation according to aspects of the present disclosure, a method, system and computing device for supporting conditional firmware images. A set of conditions may be received, wherein the conditions are based on characteristics of a computer. A set of indications corresponding to displayable images may be received. The set of conditions may be compared against a system clock of the computer. Responsive to the comparing, a section of the non-volatile memory may be set to one of the set of indications based on the comparing. One of the displayable images corresponding to the section may be displayed.

### BACKGROUND

The basic input/output system (BIOS) of a computer system controls fundamental functionality of a computer system. The functionality depends on various sorts of hardware inherent to the computer system as well as functionality within that hardware. The BIOS controls basic functionality of the system and may present a splash screen at boot.

### BRIEF DESCRIPTION OF THE DRAWINGS

FIG. 1 illustrates a system for firmware controlled conditional display of images, according to an example;

FIGS. 2A and 2B illustrate flow diagrams for the conditional displaying of images by a firmware, according to an example;

FIG. 3 is a flow diagram illustrating a method to display images conditionally by a firmware, in accordance with an example of the present disclosure; and

FIG. 4 is a computing device for supporting the conditional display of images by a firmware, according to an example.

### DETAILED DESCRIPTION

Retail systems utilized by merchants display a splash screen at startup. Merchants run periodic sales throughout the year, as well as decorate stores and showrooms for seasons and holidays. Retail systems' boot splash screens are non-descript and often display a graphic representative of the manufacturer of the retail system or a system POST screen. Historically, a BIOS install post screen or splash screen was displayed at startup. Examples disclosed herein are directed to conditional firmware boot images which change the appearance of a display at startup based on conditions.

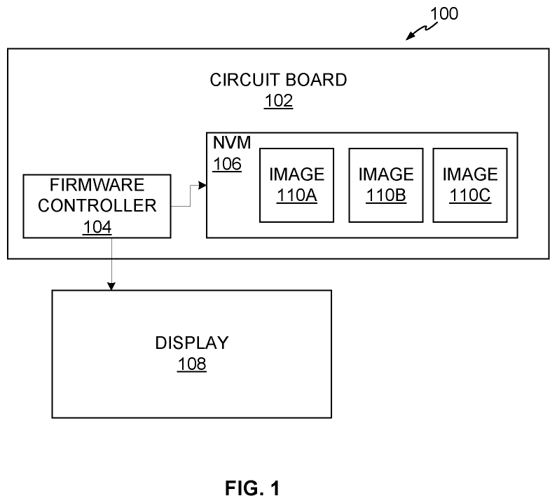

FIG. 1 illustrates a system 100 for firmware controlled conditional display of images, according to an example. The system 100 may include a circuit board 102, a firmware controller 104, non-volatile memory 106, a display 108, and images 110A, 110B, 110C.

A circuit board 102 may be utilized to support a firmware controller 104. The circuit board 102 may be of a size and shape to support both physically and electrically firmware controller 104. The circuit board 102 may support additional system resources including but not limited to memory, non-volatile memory, input/output systems, data busses, and processors. The circuit board 102 may provide electrical connectivity between the firmware controller 104 and the non-volatile memory 106.

A firmware controller 104 may be a non-volatile firmware used to perform hardware initialization during the booting of the system 100 and to provide runtime services for operating systems and programs executing on the system 100. Historically, a BIOS was utilized to initialize the underlying hardware and drivers. Subsequently, a universal extensible firmware interface (UEFI) has become popular in replacing a BIOS. The firmware controller 104 may include functionality of a UEFI to provide input for conditional criteria for the display of certain images upon. The firmware controller 104 may initialize and load device drivers of the system 100 and execute boot loader which allows a supported operating system to start. The firmware controller 104 may include conditional logic to perform determinative operations which allow for conditional startup operations. For example, the firmware controller 104 may be able to perform mathematic comparisons on various data types. Using the mathematic comparisons, the firmware controller 104 may derive more complex comparison functions allowing programmatic interfacing higher level functionality to include but not limited to accessing and identifying file systems present on storage devices.

The system may include non-volatile memory 106. The non-volatile memory 106 may be memory that can retain stored information even after having been power cycled. The non-volatile memory may include but is not limited to flash memory. The non-volatile memory 106 may also support firmware code and value states. The firmware code and value states may correspond to configuration details of the system 100. Configuration details may include system dock timings as well peripheral configuration.

display 108 may be attached to the system 100. The display 108 may be electrically coupled to the system 100. In another implementation the display 108 may be communicatively coupled to the system 100. The display 108 may be implemented on panels based on liquid crystal displays (LCDs), organic light emitting diodes (OLEDs), quantum-dot light emitting diode (QLEDs), as well as cathode ray tubes (CRTs). The display 110 may be connected to the computer through an industry standard connection interface such as high definition multimedia interface (HDMI), DisplayPort, digital visual interface (DVI), and video graphics array (VGA) interfaces with DE-15 connectors. The display 108 resolution may be dynamic and determined by the image to be displayed. In another implementation the display 108 resolution may be static and stored as a configuration detail in the non-volatile memory 106.

The system 100 may include images 110A, 110B, 110C. The images 110A, 110B, 110C may be digital representation of photographs or graphic objects. The images 110A, 110B, 110C may be stored in file formats that may be stored in the non-volatile memory. For example, the images 110A, 110B, 110C may be stored in graphic formats including but not limited to a bitmap (bmp), portable network graphic (png), graphics interchange format (gif), or joint photographic experts format (jpeg). In one implementation, the images 110A, 110B, 110C may be stored in the non-volatile memory 106, such as flash memory, in a contiguous memory segment. The images 110A, 110B, 110C may be stored in the serial peripheral interface (SPI) segment of the firmware. In another implementation, the images 110A, 110B, 110C may be stored in non-contiguous flash memory where the images 110A, 110B, 110C may still be addressable by the firmware controller 104. In another implementation, address pointers for the images 110A, 110B, 110C may be stored in the non-volatile memory 106, where the address pointers correspond to other locations across the system. In some embodiments, the other locations may include addressable storage devices such as mechanical disk drives. The images 110A, 110B, 110C may be user updatable through an UEFI interface. In another implementation images 110A, 110B, 110C may be preloaded in the non-volatile memory from the manufacturer of the system 100.

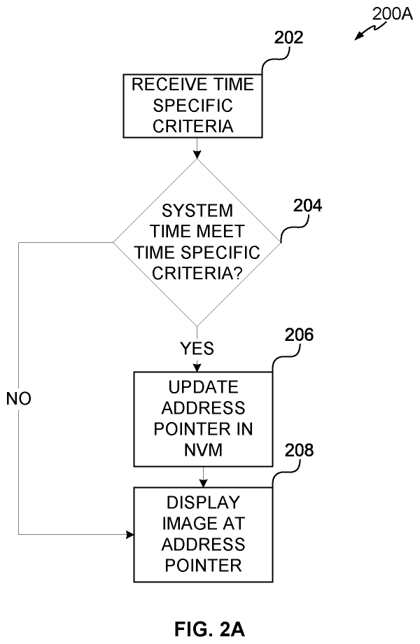

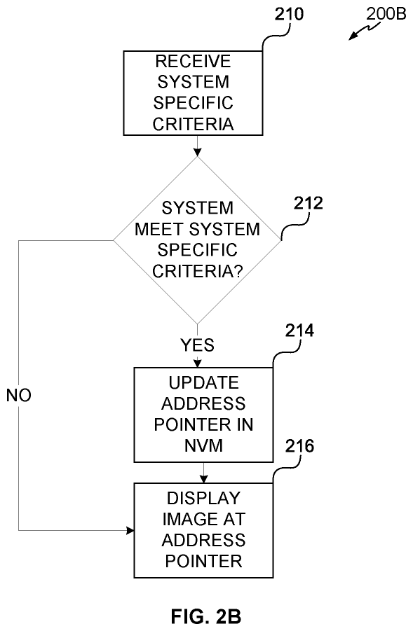

FIG. 2A illustrates a flow diagram 200A for the conditional displaying of images by a firmware, according to an example. For purposes of clarity, references to components of the system 100 of FIG. 1 may be utilized for descriptive purposes.

At step 202, the firmware controller 104 may receive time specific criteria. The time specific criteria may include a date and time stamp as indicated by user interaction. For example, a user may input a specific date or time into the firmware controller 104 through an UEFI interface. The specific date or time may correspond to an event of meaning for the user. For example, the user may be a sales associate at a brick and mortar store. The sales associate may desire the system 100 to present an image corresponding to an annual sale initiative. The sales associate may input a date and time stamp corresponding to a week before the annual sale initiative. Additionally, the time specific criteria may include a duration. The duration may include a period of time corresponding to duration of the event of meaning. The firmware controller 104 may receive the date and time stamp and store it in the non-volatile memory 106 accordingly. The date and time stamp may be stored utilizing a platform specific formatting system. In another implementation, the firmware controller 104 may receive multiple time specific criteria. Multiple time specific criteria may correspond to an event calendar for an annual period. In this implementation, for instance, the multiple time specific criteria may correspond to an annual holiday or sales schedule.

At step 204, the firmware controller 104 may compare the system time to the time specific criteria. The comparison may determine whether the system time meets the time specific criteria. For example, if the time specific criteria indicates a date and time stamp corresponding to May 9 23:00 coordinated universal time (UTC), and the system time corresponds to May 9 23:01 UTC, the system time would meet the time specific criteria. In another implementation, if the time specific criteria also include a duration, the firmware controller 104 verifies the date and time stamp plus duration. In the event that the system time exceeds the date and time stamp plus duration, the comparison fails.

At step 206, the firmware controller 104 may update the address pointer of an image in non-volatile memory. The address pointer corresponds to a memory address utilized to identify and load an image at boot time by the firmware controller 104. During default booting procedures, the address pointer may correspond to a memory location containing an image indicative of the manufacturer of the system. Based on the results of the comparison at step 204, the firmware controller 104 may update the address pointer to point to a memory location to correspond to a user specified graphic image.

At step 208, the firmware controller 104 may retrieve the image at the memory location specified by the address pointer and display an image located at the memory location. The firmware controller 104 may utilize the address pointer consistently on system boot. In one implementation, the address pointer may be the same location in nonvolatile memory. The firmware controller 104 may use additional rendering circuitry to render or raster the image located at the memory location.

FIG. 2B illustrates a flow diagram 200B for the conditional displaying of images by a firmware, according to another example. Similar to FIG. 2A, references to components of the system 100 of FIG. 1 may be utilized for descriptive purposes

At step 210, the firmware controller 104 may receive system specific criteria. System specific criteria may include identifiable information for the system including currently installed operating system. Additionally, the system specific criteria may include a feature byte stored in the non-volatile memory. The feature byte contains bit entries corresponding to particular characteristics of the system, including but not limited to manufacturer model, integrated hardware, and operating system. In one implementation, the firmware controller 104 may utilize circuitry that can access a filesystem of the system 100 to determine the operating system installed. The firmware controller 104 read the feature byte to obtain the system specific criteria.

At step 212, the firmware controller 104 may compare the system specific criteria to particular characteristics of the system. The comparison may determine whether the system configuration meets the system specific criteria. For example, if the feature bit included a mask for the Linux operating system, and the system specific criteria required the Linux operating system, then the comparison would succeed, In another implementation, the firmware controller 104 may utilize additional functionality to query characteristics of the system 100. In systems without feature bytes, the firmware controller 104 may utilize an application programing interface (API) to determine system characteristics. The firmware controller 104 may examine the master boot record. The master boot record may indicate to the firmware controller 104 the operating system installed on the system. If the indicated operating system corresponds to an operating system in the system specific criteria, the comparison succeeds. However, if the operating system does not match that in the system specific criteria, the comparison fails.

At step 214, the firmware controller 104 may update the address pointer of an image in non-volatile memory. As described above, the address pointer corresponds to a memory address utilized to identify and load an image at boot time by the firmware controller 104. During default booting procedures, the address pointer may correspond to a memory location containing an image indicative of the manufacturer of the system. Based on the results of the comparison at step 212, the firmware controller 104 may update the address pointer to point to a memory location to correspond to a user specified graphic image.

At step 216, the firmware controller 104 may retrieve the image at the memory location specified by the address pointer and display an image located at the memory location. The firmware controller 104 may utilize the address pointer consistently on system boot. In one implementation, the address pointer may be the same location in nonvolatile memory. The firmware controller 104 may use additional rendering circuitry to render or raster the image located at the memory location.

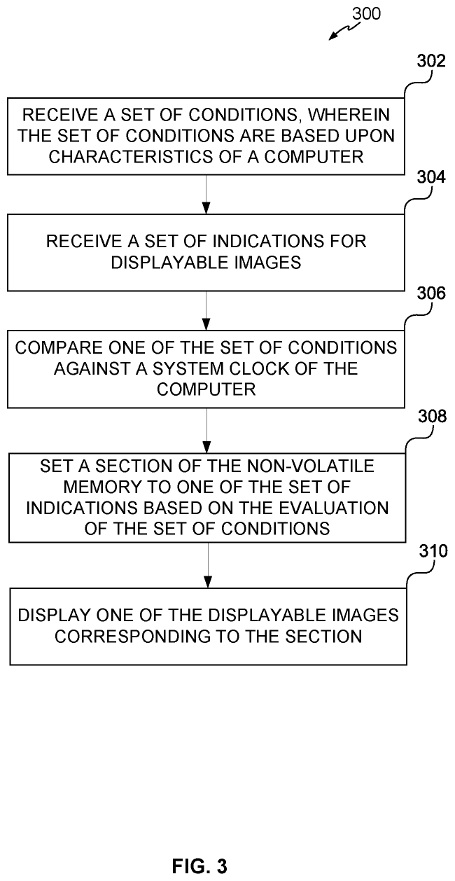

FIG. 3 is a flow diagram 300 illustrating a method to display images conditionally by a firmware, in accordance with an example of the present disclosure.

At step 302, a firmware controller 104 may receive a set of conditions, wherein the set of conditions are based upon characteristics of a computer. The set of conditions may be system specific criteria, time specific criteria or a combination thereof. In one implementation, the set of conditions may include system specific criteria and time specific criteria. The set of conditions may correspond to an operational state of the system. For example, the set of conditions may set a system specific condition for a default operation state. Additionally, a time specific condition may be utilized for periodic operation states. In this example, the default operation state may be a non-sale event period in a retail environment, where the system presents a graphic at boot with the company's logo. The periodic operation states may be different from the default operation state where the retail environment is in a sale or holiday period and the system presents a graphic corresponding to the sale or holiday. The characteristics of a computer may include but are not limited to the aforementioned characteristics represented in the feature byte, as well as configuration options detectable through application programming interfaces including master boot record information.

The set of conditions may be received as a configuration written to non-volatile memory by a tool in manufacturing. The tool may be a flash memory writer provided by the manufacturer of the system. Additionally, the receipt of the set of conditions may be a user interaction. The set of conditions may be input into the system through the use of a graphical user interface such as aforementioned UEFI interface to the firmware controller 104. In another implementation, the set of conditions may be received through a network controller (not shown) that is communicatively coupled with the firmware controller 104. The set of conditions may be uploaded to the system remotely over a network connection. The network connection may include wired and wireless based systems that may deliver the set of conditions. Additionally, the set of indications may include a pointer to addressable media different from the non-volatile memory. For example, the pointer may address a displayable image stored on a system disk drive or in local random-access memory.

At step 304, the firmware controller may receive a set of indications for displayable images. The set of indications may correspond to memory locations of a set of displayable images. The set of indications may be utilized for reference addressing of the images during the system boot procedure by the firmware controller. Any image corresponding to the each of the set of indications may be transferrable to a frame buffer and displayed on a display.

At step 306, the firmware controller may compare one of the set of conditions against a system dock of the computer. As the set of conditions may include time specific criteria, the firmware controller may compare a time specific criteria against the system dock of the system. As described in reference to FIG. 2A, if the set of conditions are successful, the firmware controller may proceed to update the display of a conditional image.

At step 308, the firmware controller may set a section of the non-volatile memory to one of the set of indications based on the evaluation of the set of conditions. As described previously, the firmware controller may update an address pointer to point to one of the set of displayable images. By setting only a pointer to the image, the firmware controller may limit the amount of data read or written to areas of non-volatile memory or other storage locations.

At step 310, the firmware controller may display one of the displayable images corresponding to the section. As described previously, the firmware controller may provide the values at the memory locations corresponding to the set of indications

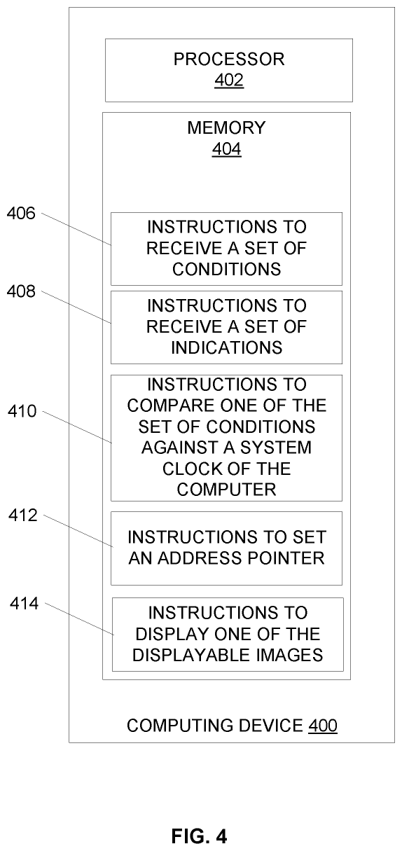

FIG. 4 is a computing device for supporting the conditional display of images by a firmware, according to an example.

The computing device 400 depicts a processor 402 and a memory device 404 and, as an example of the computing device 400 performing its operations, the memory device 404 may include instructions 406-414 that are executable by the processor 402. The processor 402 may be synonymous with the firmware controller 104 or additionally processors found in common computing environments including but not limited to central processing units (CFUs).Thus, memory device 404 can be said to store program instructions that, when executed by processor 402, implement the components of the computing device 400. The executable program instructions stored in the memory device 404 include, as an example, instructions to receive a set of conditions 406, instructions to receive a set of indications corresponding to displayable images 408, instructions to compare one of the set of conditions against a system clock of the computer 410, instructions to set a hardware address pointer 412, and instructions to display one of the displayable images 414.

Memory device 404 represents generally any number of memory components capable of storing instructions that can be executed by processor 402. Memory device 404 is non-transitory in the sense that it does not encompass a transitory signal but instead is made up of at least one memory component configured to store the relevant instructions. As a result, the memory device 404 may be a non-transitory computer-readable storage medium. Memory device 404 may be implemented in a single device or distributed across devices. Likewise, processor 402 represents any number of processors capable of executing instructions stored by memory device 404. Processor 402 may be integrated in a single device or distributed across devices. Further, memory device 404 may be fully or partially integrated in the same device as processor 402, or it may be separate but accessible to that device and processor 402.

In one example, the program instructions 406-414 can be part of an installation package that, when installed, can be executed by processor 402 to implement the components of the computing device 400. In this case, memory device 404 may be a portable medium such as a CD, DVD, or flash drive, a memory maintained by a server from which the installation package can be downloaded and installed, or a non-volatile memory as described in reference to FIG. 1. In another example, the program instructions may be part of an application or applications already installed. Here, memory device 404 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a non-volatile memory; and
a firmware controller to:
receive a set of conditions, wherein the set of conditions are based upon characteristics of a computer;
receive a set of indications for displayable images;
evaluate the set of conditions during a boot sequence of the computer;
set a section of the non-volatile memory to one of the set of indications based on the evaluation of the set of conditions; and
display one of the displayable images corresponding to the section.

2. The system of claim 1, wherein the characteristics of the computer comprise a feature byte.

3. The system of claim 1, wherein the characteristics of the computer comprise master boot record information,

4. The system of claim 1, wherein the set of conditions correspond to an operational state of the computer.

5. The system of claim 1, wherein the one of the set of indications comprises a pointer to addressable media different from the non-volatile memory where one a displayable image is stored.

6. A method comprising:
receiving a set of conditions, wherein the set of conditions are based upon characteristics of a computer;
receiving a set of indications for displayable images;
comparing one of the set of conditions against a system clock of the computer;
setting, responsive to the comparing, a section of a non-volatile memory to one of the set of indications based on the comparing of the set of conditions; and
displaying one of the displayable images corresponding to the section.

7. The method of claim 6, wherein the characteristics of the computer comprise a feature byte.

8. The method of claim 6, wherein the characteristics of the computer comprise master boot record information.

9. The method of claim 6, wherein the set of conditions correspond to an operational state of the computer.

10. The method of claim 6, wherein the one of the set of indications comprises a pointer to addressable media different from the non-volatile memory.

11. A computing device comprising:
a memory having instructions stored thereon and
a processor configured to perform, when executing the instructions to:
receiving a set of conditions, wherein the set of conditions are based upon characteristics of a computer;
receiving a set of indications for displayable images;
comparing one of the set of conditions against a system clock of the computer;
setting, responsive to the comparing, an address pointer to one of the set of indications based on the evaluation of the set of conditions; and
displaying one of the displayable images corresponding to the section.

12. The computing device of claim 11, wherein the characteristics of the computer comprise a feature byte.

13. The computing device of claim 11, wherein the characteristics of the computer comprise master boot record information.

14. The computing device of claim 11, wherein the set of conditions correspond to an operational state of the computer.

15. The computing device of claim 11, wherein the one of the set of indications comprises a pointer to addressable media different from the non-volatile memory where one a displayable image is stored.
